(19) United States
(12) Patent Application Publication
(10) Pub. No.: US 2026/0028180 A1
(43) Pub. Date: Jan. 29, 2026

(54) WASTE CONTAINER ADAPTED FOR CAT LITTER AND ALIKE

(71) Applicant: J. E. Mondou Ltée, Anjou (CA)

(72) Inventors: Michaël SINGLETON, Laval (CA); Michael MAURICE, Saint-Hyacinthe (CA); Alexis RAJOTTE, Marieville (CA)

(21) Appl. No.: 19/198,439

(22) Filed: May 5, 2025

Related U.S. Application Data
(60) Provisional application No. 63/674,624, filed on Jul. 23, 2024.

(51) Int. Cl. B65F 1/16; B65F 1/06

(52) U.S. Cl. CPC B65F 1/1607; B65F 1/06; B65F 1/1646; B65F 2240/136

(57) ABSTRACT

A waste container has a base providing a room for a liner to be put in to receive waste material, an intermediary part having an internal shell, and a lid mounted on top of one another. The waste container has a gate that controllably closes the internal shell, closing thereby the room. The waste container has a mechanism that comprises a member coupling the lid to the gate, thereby closing the gate when the lid opens. The mechanism comprises hooks holding the gate closed, and hook-release components coupled to the lid that, when closing the lid, release the gate from the closed position. Once released, the gate rotates downwards such 10 that waste material placed thereon falls into the room. Such a waste container minimizes the odors released from waste material in the room when collecting new waste material and placing it onto the gate.

### CROSS-REFERENCE TO RELATED APPLICATION

This application relates to and is a non-provisional application claiming priority under 35 U.S.C. § 119(e) and 37 C.F.R. § 1.78(a) for a priority claim to earlier-filed provisional application Ser. No. 63/674,624, filed Jul. 23, 2024, under 35 U.S.C. § 111, entitled WASTE CONTAINER ADAPTED FOR CAT LITTER AND ALIKE, the specification of which is hereby incorporated herein by reference in its entirety.

### BACKGROUND

### (a) Field

The subject matter disclosed generally relates to waste containers. More particularly, the subject matter disclosed relates to containers for storing animal waste, that minimizes exposure to the user of odor from waste stored in the container.

### (b) Related Prior Art

Pet waste, particularly canine and feline waste, is commonly stored in individual plastic bags and then disposed of in a trash can, or waste container. The cumulative odor of the pet waste, along with other waste stored within the trash can, can reach an offensive level such that it is difficult to use the trash can, and the trash can must in consequence be emptied before it is full in order to minimize the odor.

There are a variety of known waste containers that minimize odor of human feces by creating individually wrapped packages of waste that are stored in the container. These containers use special liners that are twisted around the waste. These liners can be expensive to replace. Additionally, the cumulative odor escaping from the packages of waste can still become quite strong and offensive such that the waste container must still be emptied before it reaches full capacity.

Furthermore, some waste containers have lids which are effective to contain odors when the container's lid is closed, but the user is exposed to the cumulative odor each time the user opens the lid to place more waste within the container.

Accordingly, the need exists for a waste container which effectively contains the waste odor and minimizes the user from being exposed to the odor even when the user places more waste within the container. There is further a need for waste containers than minimize the numbers of necessary bags or liners.

### SUMMARY

According to an embodiment, the present invention provides a waste container with an upper lid and an internal lower lid provided over a base chamber in which waste is stored, to minimize a user's exposure to odor from waste.

In some aspects, the description herein relates to a waste container, including: a base providing a room therein for waste material; an intermediary part to be mounted to the base, the intermediary part including an internal shell providing an internal access to the room; a gate rotatably mounted to the intermediary part, the gate being movable between a gate-opened position wherein the internal access to the room is open, and a gate-closed position where the internal access to the room is blocked by the gate; a lid rotatably mount to the intermediary part, the lid being movable between a lid-opened position in which an external access to the internal shell of the intermediary part is open, and a lid-closed position in which the internal access to the internal shell is blocked by the lid; and a coupling member coupling the lid to the gate, wherein moving the lid from the lid-closed position to the lid-opened position exerts the gate into the gate-closed position.

In some aspects, the description herein relates to a waste container, wherein the coupling member has an arched shape.

In some aspects, the description herein relates to a waste container, wherein the base includes a resting part adapted to be laid over ground, wherein the intermediary part includes an edge defining a circumference providing an internal opening, wherein the internal opening is adapted to extend slanted relative to the resting part.

In some aspects, the description herein relates to a waste container, wherein the lid-closed position and the gate-closed position are sloped relative to one another.

In some aspects, the description herein relates to a waste container, wherein the coupling member extends across a section of the intermediary part.

In some aspects, the description herein relates to a waste container, wherein the coupling member is slidingly movable relative to the gate.

In some aspects, the description herein relates to a waste container, wherein the intermediary part includes a protrusion extending across the gate.

In some aspects, the description herein relates to a waste container, wherein the protrusion ends with a hook, wherein the lid includes a push member adapted to controllably push the protrusion, thereby having the hook releasably hooking the gate.

In some aspects, the description herein relates to a waste container, wherein the internal shell had a funnel shape having a first opening area about the base and a second opening area about the lid, wherein the first opening area is smaller than the second opening area.

In some aspects, the description herein relates to a waste container, wherein the coupling member is rotatably mounted to the lid.

In some aspects, the description herein relates to a waste container, including: a holding member providing a room therein for waste material, the holding member including i) an internal opening that is closeable and divides the room between a first room section and a second room section when closed, and ii) a external opening that is closeable; a gate mounted to the holding member, the gate being movable between a gate-opened position wherein the first room section and the second room section are unpartitioned, and a gate-closed position where the gate partitions the room thereby preventing travel between the first room section and the second room section; a lid mounted to the holding member, the lid being movable between a lid-opened position providing access to the first room section, and a lid-closed position in which the lid closes the external opening; and a coupling member coupling the lid to the gate, wherein moving the lid from a lid-closed position to the lid-opened position exerts the gate into the gate-closed position.

In some aspects, the description herein relates to a waste container, wherein the gate is rotatably mounted to the holding member.

In some aspects, the description herein relates to a waste container, wherein the coupling member has an arched shape.

In some aspects, the description herein relates to a waste container, wherein the holding member includes a base and an intermediary part releasably mounted to the base.

In some aspects, the description herein relates to a waste container, wherein the holding member includes a floor section and an interior shell extending from the external opening to the internal opening distant to the floor section.

In some aspects, the description herein relates to a waste container, wherein the holding member includes a resting part adapted to be laid over ground, wherein the internal opening is adapted to extend slanted relative to the resting part.

In some aspects, the description herein relates to a waste container, wherein the lid-closed position and the gate-closed position are sloped relative to one another.

In some aspects, the description herein relates to a waste container, wherein the coupling member extends across a section of the holding member.

In some aspects, the description herein relates to a waste container, wherein the holding member includes a protrusion extending across the gate.

In some aspects, the description herein relates to a waste container, wherein the protrusion ends with a hook, wherein the lid includes a push member adapted to controllably push the protrusion, thereby having the hook releasably hooking the gate.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1A is a perspective view of a waste container free of window and comprising an odor filter in accordance with an embodiment;

FIG. 1B is a perspective elevation view of a waste container comprising a window and free of an odor filter in accordance with an embodiment;

FIG. 2 is a rear view of the waste container of FIG. 1B;

FIG. 3 is a side view of the waste container of FIG. 1B;

FIG. 4 is an exploded perspective elevation oblique view of the waste container of FIG. 1A;

FIG. 5 is a side view of the base of any one of the waste container of FIG. 1A and of FIG. 1B;

FIG. 6 is a plan view of the base of FIG. 5;

FIG. 7 is a perspective elevation view of the intermediary part of the waste container of FIG. 1B;

FIG. 8 is a front view of the intermediary part of FIG. 7;

FIG. 9 is a bottom plane view of the intermediary part of FIG. 7;

FIG. 10 is a perspective bottom oblique view of the intermediary part of FIG. 7;

FIG. 11 is a side view of the intermediary part of FIG. 7;

FIG. 12 is a cross-section view of the intermediary part of FIG. 7 according to cross-section lines 12-12 of FIG. 11;

FIG. 13 is a detailed view of the part of the intermediary part of FIG. 7 identified with line -13- in FIG. 12;

FIG. 14 is a detailed view of the part of the intermediary part of FIG. 7 identified with line -14- in FIG. 11;

FIG. 15 is a perspective elevation view of the base of the lid of the waste container of FIG. 1B in accordance with an embodiment;

FIG. 16 is a perspective view of a cap of the lid of the waste container of FIG. 1B in accordance with an embodiment;

FIG. 17 is a side view of the lid base of FIG. 15;

FIG. 18 is a bottom plan view of the lid base of FIG. 15;

FIG. 19 is a detailed view of the part of the lid base identified with line -19- on FIG. 18;

FIG. 20 is a front elevation view of the lid base of FIG. 15;

FIG. 21 is a cross-section view of the lid base of FIG. 15 according to cross-section lines 21-21 of FIG. 20;

FIG. 22 is a perspective bottom oblique view of the lid base of FIG. 15;

FIG. 23 is a perspective elevation view of the gate of the waste container of FIG. 1B;

FIG. 24 is a side elevation view of the gate of FIG. 23;

FIG. 25 is a front elevation view of the gate of FIG. 23;

FIG. 26 is a plan view of the gate of FIG. 23;

FIG. 27 is a detailed view of the part of the gate of FIG. 23 identified through line-27-on FIG. 26;

FIG. 28 is a bottom view of the gate of FIG. 23;

FIG. 29 is a perspective elevation view of the member of any one of the waste container of FIG. 1A and of FIG. 1B;

FIG. 30 is a plan view of the member of FIG. 29;

FIG. 31 is a side elevation view of the member of FIG. 29;

FIG. 32 is a perspective elevation view of the window of the waste container of FIG. 1B;

FIG. 33 is a front elevation view of the window of FIG. 32;

FIG. 34 is a left-side cross-section view of the waste container of

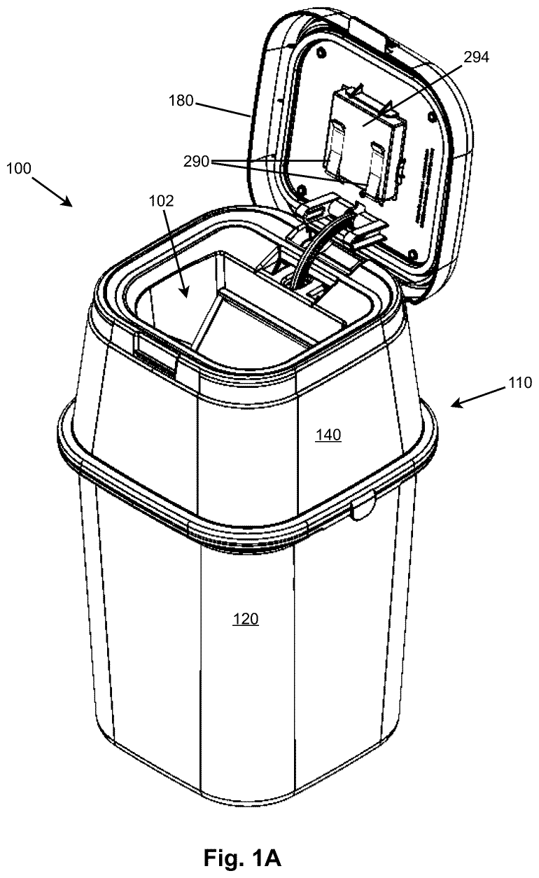

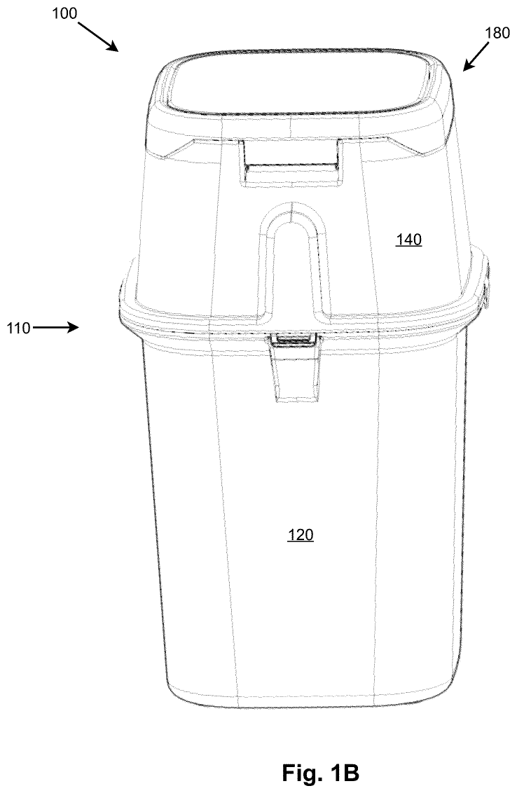

FIG. 1A, with the base hidden and with the lid in a closed position;

FIG. 35 is a 75% left-side partial cross-section view of the waste container of FIG. 1A, with the base hidden and the lid in an opened position;

FIG. 36 is a 90% left-side partial cross-section view of the waste container of FIG. 1A, with the base, the lid and the member hidden (and the hooks hidden), and with the gate in a lifted position;

FIG. 37 is a 75% left-side partial cross-section view of the waste container of FIG. 1A, with the base and the lid hidden and with the gate in a lifted position;

FIG. 38 is a 40% left-side partial cross-section view of the waste container of FIG. 1A, with the gate open and with the lid in the closed position; and

FIG. 39 is a 75% left-side partial cross-section view of the waste container of FIG. 1A, with the lid in-between the closed position and the opened position.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about”, “approximately”, or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as”, or the like) provided herein, is intended merely to better illuminate the exemplary realizations and does not pose a limitation on the scope of the realizations. No language in the specification should be construed as indicating any unclaimed element as essential to the practice of the realizations. The use of the term “substantially” is intended to mean “for the most part” or “essentially” depending on the context. It is to be construed as indicating that some deviation from the word it qualifies is acceptable as would be appreciated by one of ordinary skill in the art to operate satisfactorily for the intended purpose.

In the following description, it is understood that terms such as “first”, “second”, “top”, “bottom”, “above”, “below”, and the like, are words of convenience and are not to be construed as limiting terms.

The terms “top”. “up”. “upper”, “bottom”, “lower”, “down”, “vertical”, “horizontal”, “interior” and “exterior” and the like are intended to be construed in their normal meaning in relation with normal use of the waste container.

It should further be noted that for purposes of this disclosure, the term “coupled” means the joining of two members directly or indirectly to one another. Such joining may be stationary in nature or movable in nature and/or such joining may allow for the flow of fluids. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

In realizations, there are disclosed a waste container 100, wherein the waste container is particularly adapted for animal waste such as litter.

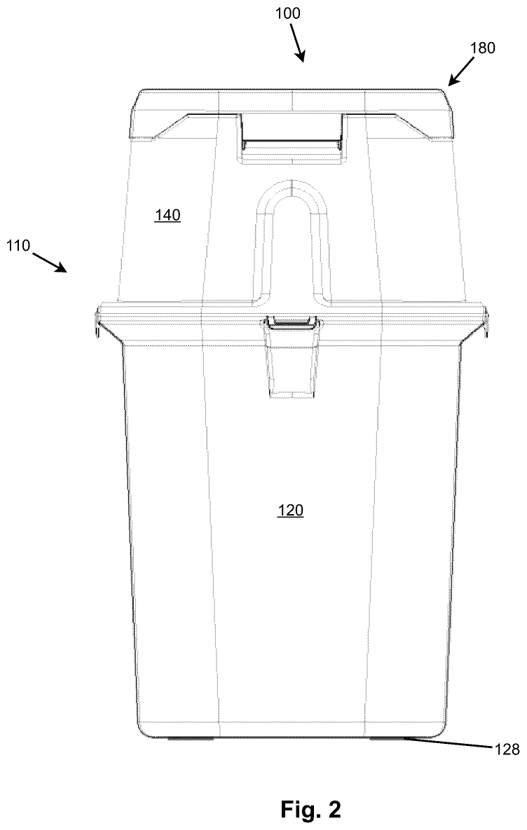

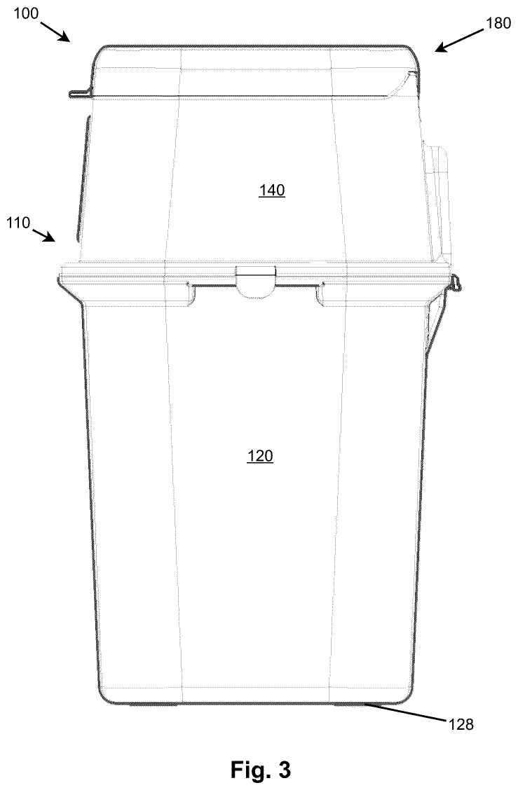

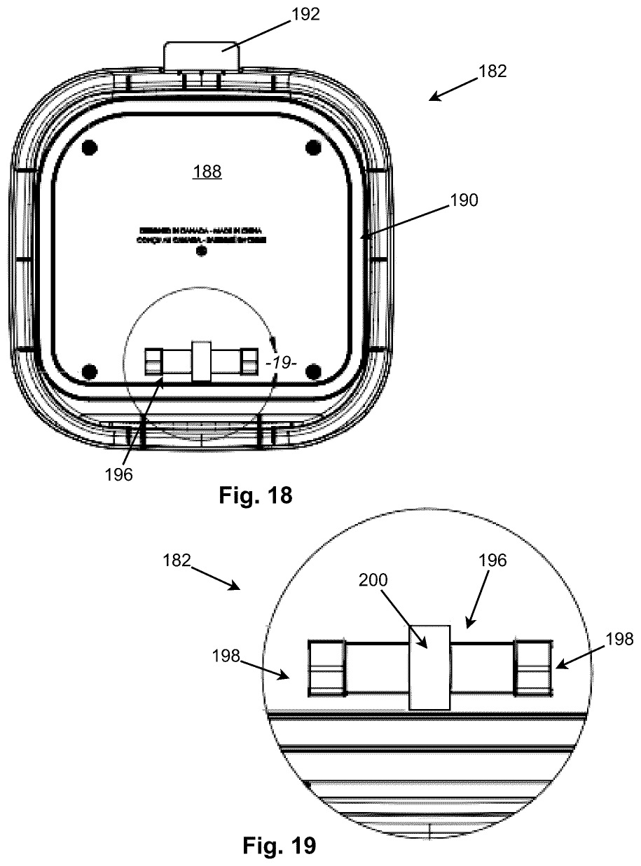

Referring now to the drawings, and more particularly to FIGS. 1A, FIG. 18 and FIGS. 2 to 4, the waste container 100 comprises a holding member 110 comprising a base 120, designed to rest on the resting part 128 (e.g. resting part or feet), and an intermediary part 140 to releasably mountable to the base 120, wherein the intermediary part can be removed to place a liner inside the base 120 and to close the waste container 100 for usage. The waste container 100 further comprises a lid 180 rotatably mounted thereto. The waste container 100 also comprises a gate 220 rotatably mounted in the room 102 defined by the base 120, the intermediary part 140 and the lid 180 with parts of a mechanism comprising a coupling member 260 allowing to control opening and closure of the gate 220.

The room 102 is divided in two room sections: a first room section 102a and a second room section 102b that can be controllably partitioned and unpartitioned, temporarily separated from one another and accessible to one another, preventing and allowing access of material and odor between the first room section 102a and the second room section 102b.

According to an embodiment depicted through FIG. 1B, the intermediary part 140 comprises an opening 178 at the front, closed by a transparent window 280, allowing the user to evaluate the content of the room 102, to determine when to empty the waste container 100 by removing the intermediary part 140 from on top of the base 120, removing the liner and its content from inside the base 120 and replacing the used liner with a new liner.

According to an embodiment depicted through FIG. 1A, the intermediary part 140 is free of an opening at the front, thus having the window replaced with a continuous wall. The lid 180 comprises on the interior side holding means 290, e.g., two elongated hooks, adapted to releasably mount an odor filter 294.

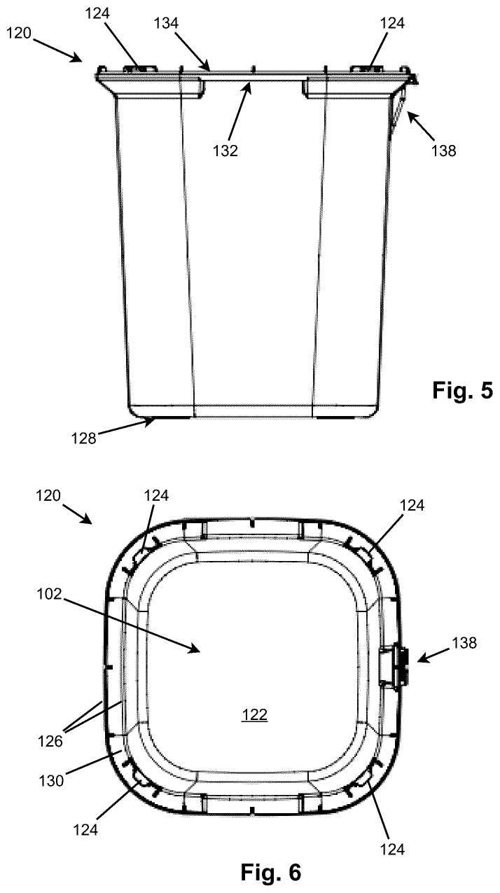

Referring to FIGS. 5 and 6, the base 120 of the waste container 100 consists in an open-top container adapted to provide part of the room 102 therein closed at the bottom by a floor section 122. The base 120 comprises about its top edge 134 means, e.g., hooks 124 adapted for removably securing a liner therein, therefore keeping the inside of the base 120 clean regardless of the waste temporarily stored in the room 102. The base 120 further comprises about its top edge 134 means, e.g., lips 126 and seal 130 adapted to cooperate with the intermediary part 140 in providing a relatively sealed room 102 relative to their interconnection. The base 120 may further comprise means, e.g., recesses 132, used to cooperate with the intermediary part 140 in releasably securing the base 120 and the intermediary part 140 together such that one user, e.g., lifting the waste container 100 by the intermediary part 140 would not open the room 102 accidentally.

According to an embodiment, a fastener 138 may take place on the exterior, for holding accessories, such as a scoop holder. It is hereby contemplated that the present waste container 100 may comprise additional features to improve general use or specific to particular use, such as use with animal litter.

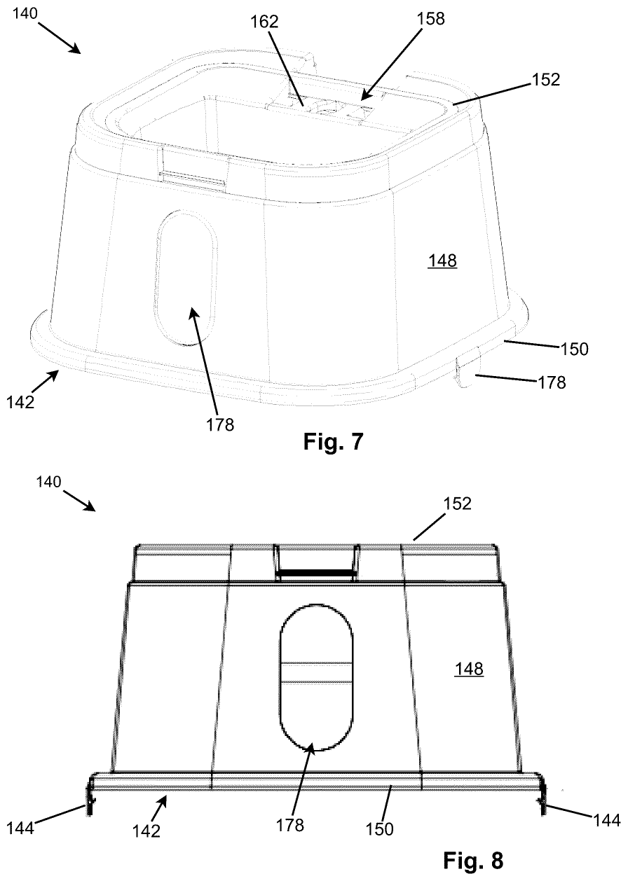

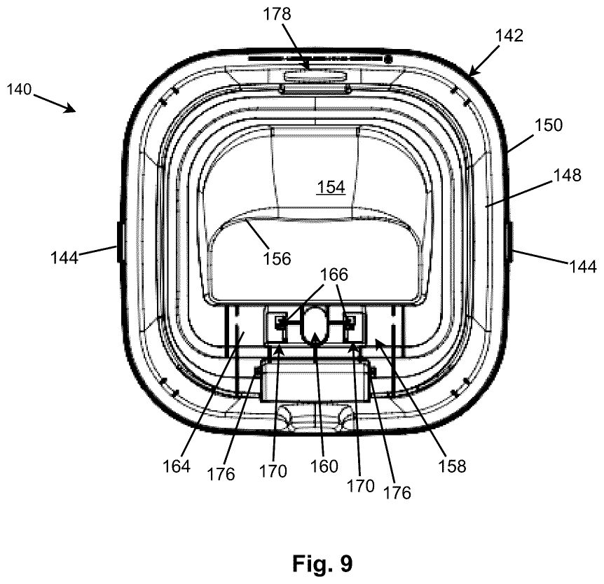

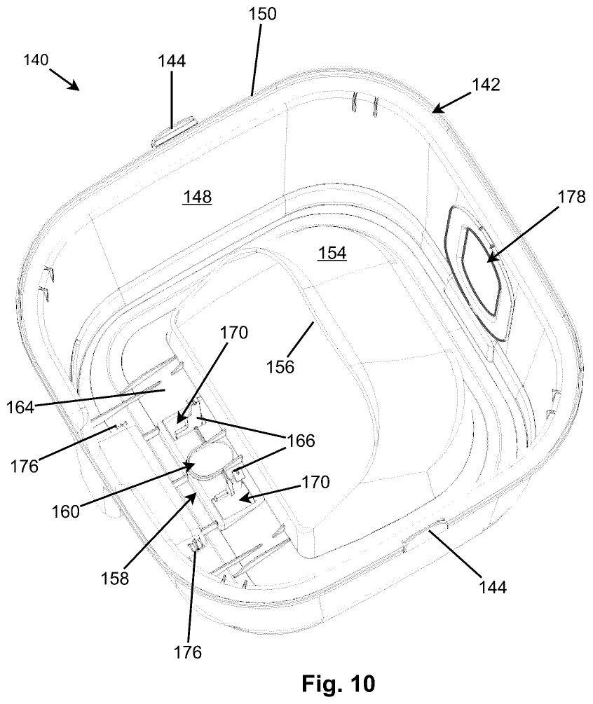

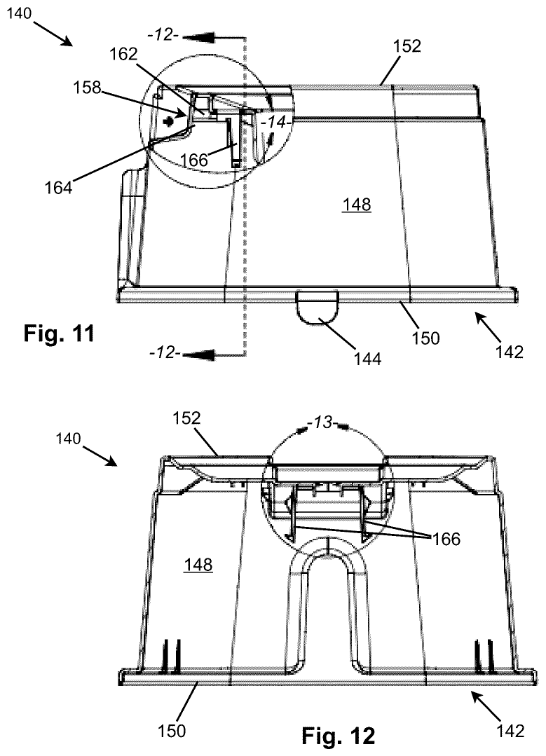

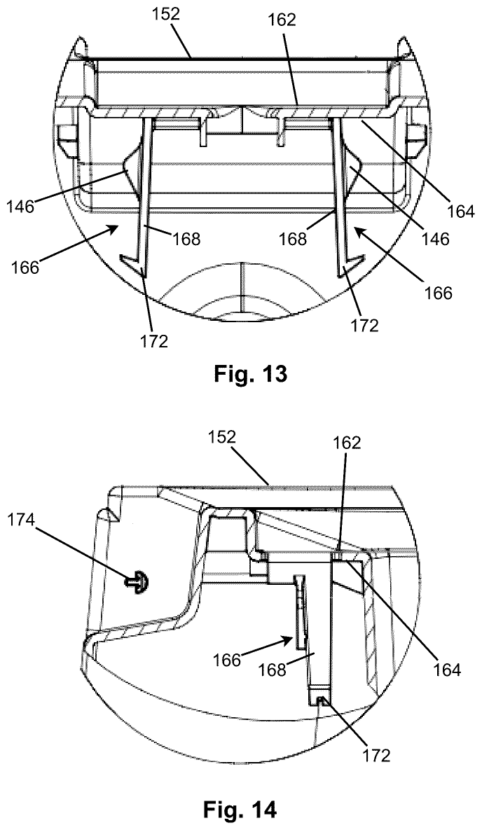

Referring to FIGS. 7 to 15, the intermediary part 140 of the waste container 100 consists in a component adapted to take place between the base 120 and the lid 180 that allows to access the liner placed in the base 120 without having the gate-operating mechanism as a hindrance. The intermediary part 140 comprises a base interface 142 adapted to marry the top edge 134 of the base 120 when put thereon. The intermediary part 140 further comprises releasable hooks 144 adapted to hook the sides of the base 120, to take place in the recesses 132, and therefore to hold on the base 120 until pulled away from the base 120.

The intermediary part 140 comprises an external shell 148 joining its bottom edge 150 and its top edge 152.

The intermediary part 140 further comprises an internal shell 154 extending from the top edge 152 towards the base 120. The internal shell 154 substantially performs the function of a funnel providing a sloped surface towards the base 120, the funnel having a smaller bottom opening area than its top the top opening area. The internal shell 154 further comprises a bottom edge 156 where the internal shell 154 is opened to the room 102, with the bottom edge 156 adapted to interface with the gate 220 such that the room 102 is controllably opened (in a gate-opened position) or closed (in a gate-closed position) depending on the gate 220 either abutting the bottom edge 156 or not. The bottom edge 156 thus defines a circumference providing an internal opening that can be controllably closed with the gate 220.

The top edge 152 of the intermediary part 140 further comprises a rear rim portion 158 that has a top face 162 facing upwards and a bottom face 164 facing the room 102. The rear rim portion 158 features a central opening 160 that provides room for the coupling member 260 to travel. Additionally, side openings 170 are set aside the central opening 160 for the lid 180 to interact with hooks 166 as is explained further hereinafter. The hooks 166 extend from the bottom face 164 aside the additional openings 170. The hooks 166 as adapted to interface with the gate 220 as explained hereinafter. Each one of the hooks 166 comprises a body 168 releasably flexible, a protrusion 146 extending on the of the body 168 proximate to the near side opening 170, more precisely under the side opening 170, and a hooking end 172 distant to the bottom face 164.

The intermediary part 140 further comprises lid-mounting lugs 174 extending sideways slightly above the rear rim portion 158 for the lid 180 be rotatably coupled thereto, and gate-mounting lugs 176 extending sideways below the rear rim portion 158 for the gate 220 to be rotatably coupled thereto.

The whole configuration of the intermediary part 140 is adapted to substantially prevent odors released by the content of the room 102 to escape therefrom. The combination of the external shell 148, the internal shell 154, and the gate 220 when abutting the slanted bottom edge 156 of the internal shell 154, are closing the room 102. The only escape route for the odors that remains are the central opening 160 and the side openings 170 that are located at the rear, relatively far to the user, with the coupling member 260 travelling therein decreasing size of the area the odors may escape through.

Therethrough, the waste container 100 features a room over the gate that is sloped at its bottom relative to the resting part 128 and at its top, closed by the lid 180 that is substantially parallel to the resting part 128. Thus, the general plane of the gate 220 abutting the bottom edge 156 in its gate-closed position is sloped relative to the general plane of the lid 180 in its lid-closed position.

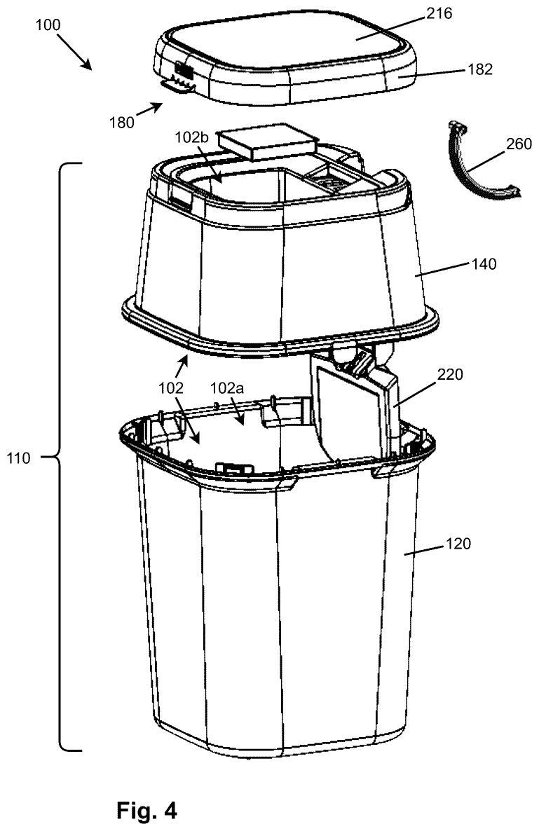

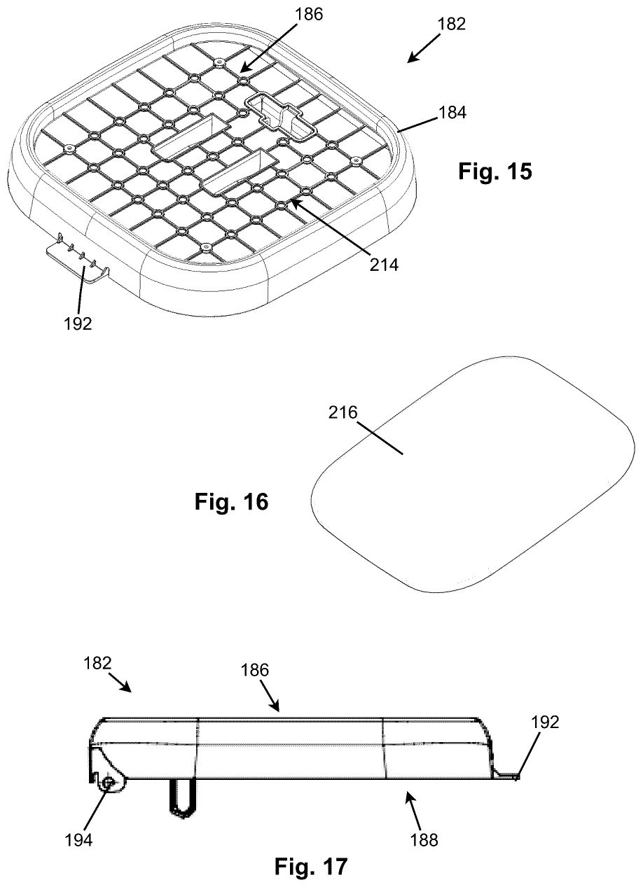

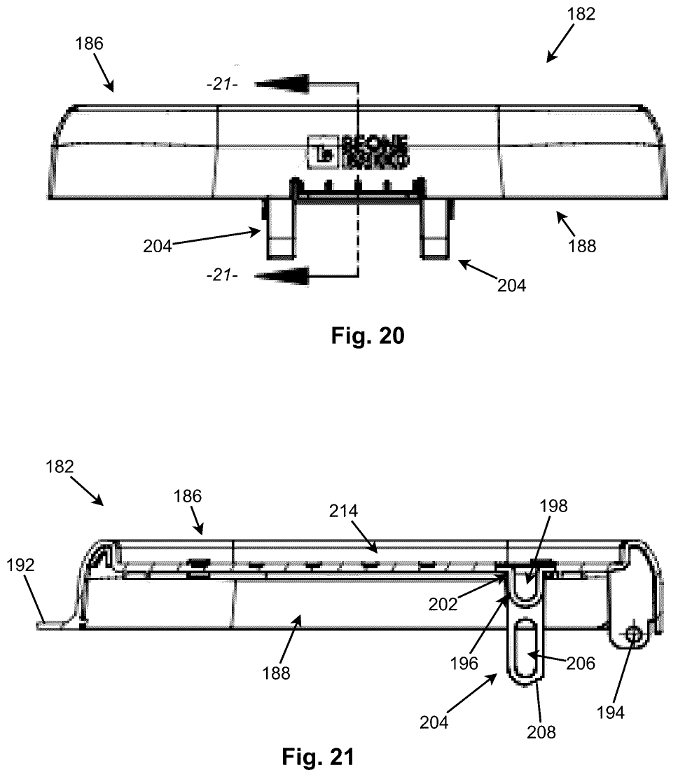

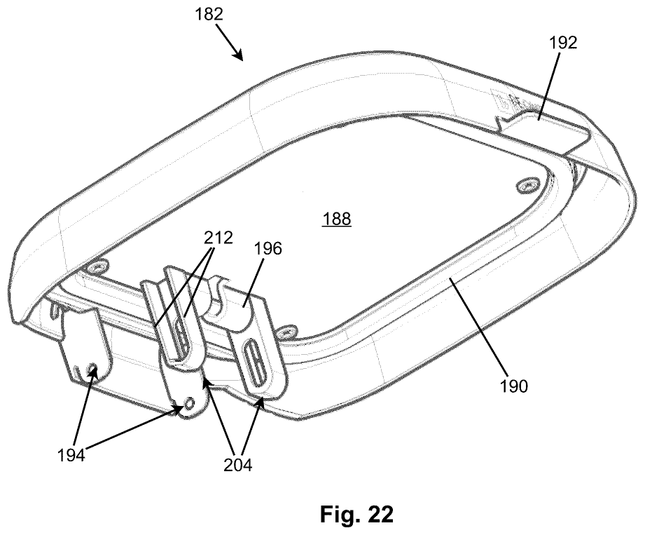

Referring to FIGS. 15 to 22 in light of FIG. 4, the base 182 of the lid 180 of the waste container 100 consists of a body 184 having a top face 186 and a bottom face 188. The bottom face 188 comprises an interfacing surface 190 adapted to set on the top edge 152 of the intermediary part 140 to controllably close the waste container 100, or in other words to provide controlled access to the room 102 inside the waste container 100. According to an embodiment, an e.g., EPDM seal is glued to the bottom face 188, the seal providing the interfacing surface 190. When closing the lid, the seal is compressed over the intermediary part 140.

According to one embodiment, the lid 180 is manually operated. The base 182 comprises a tongue 192 extending from the front portion of the top face 186, and more precisely extending frontwards from a front-facing portion of the top face 186. So, a user wanting to open the waste container 100 may simply lift the tongue 192.

The base 182 comprises holes 194 located at the rear extending sideways. The holes 194, when the lid 180 is coupled to the intermediary part 140, have the lid-mounting lugs 174 of the intermediary part 140 inserted into to rotatably mount the base 182 to the intermediary part 140.

The base 182 further comprises, substantially on the bottom face 188, a member-coupling interface 196 adapted for the coupling member 260 to be coupled thereto, dynamically coupling thereby the lid 180 to the gate 220 as explained further hereinafter. According to one embodiment, the member-coupling interface 196 comprises of channel 198 having a substantially cylindrical floor for an end of the coupling member 260 to set in, and an opening 200 sized for the other end and body of the coupling member 260 to be inserted through the opening 200. According to an embodiment, the channel 198 comprises constraints 202 above the channel-member contacting location that prevent the coupling member 260 to easily exit the channel 198.

The base 182 further comprises, extending from the bottom face 188, push members 204 that are adapted to travel in the side openings 170 of the intermediary part 140 and interact with the hooks 166 as explained further hereinafter. The push members 204 comprise an abutting end 208 interacting with the hook 166, and an opening 206 providing clearance, and side lip 212 providing rigidity to the push members 204, ensuring that the hooks 166 will flex rather than the push members 204 flexing when interacting.

The lid 180 further comprises a cap 216 sizes to wedge in the housing 214 defined by the shape of the top face 186 of the base 182. The cap 216 fluidly closes the base 182 and provides a further hindrance against the coupling member 260 getting out of the member-coupling interface 196.

It is worth noting that the lid 180 closes the intermediary part 140. So, when the lid 180 is closed, moving from a lid-opened position to a lid-closed position, no opening remains for the odors of the content of the room 102 to escape the waste container 100.

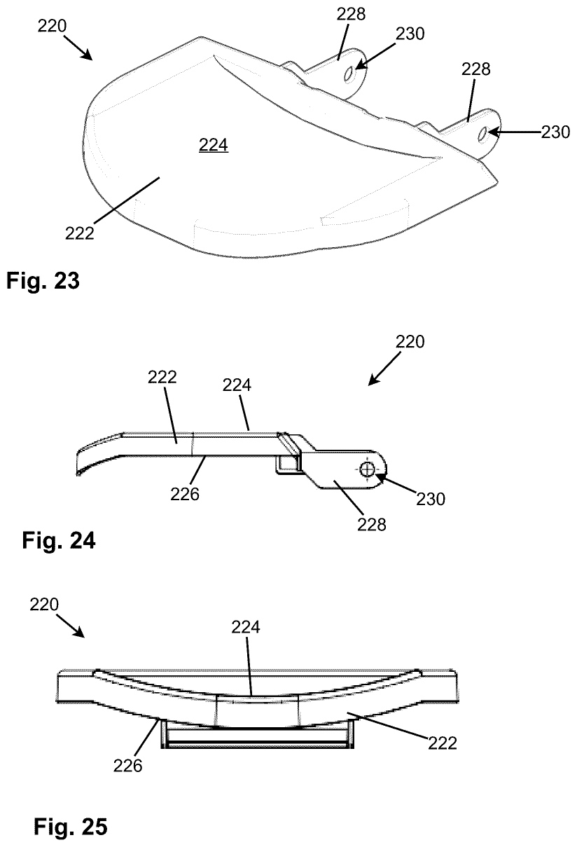

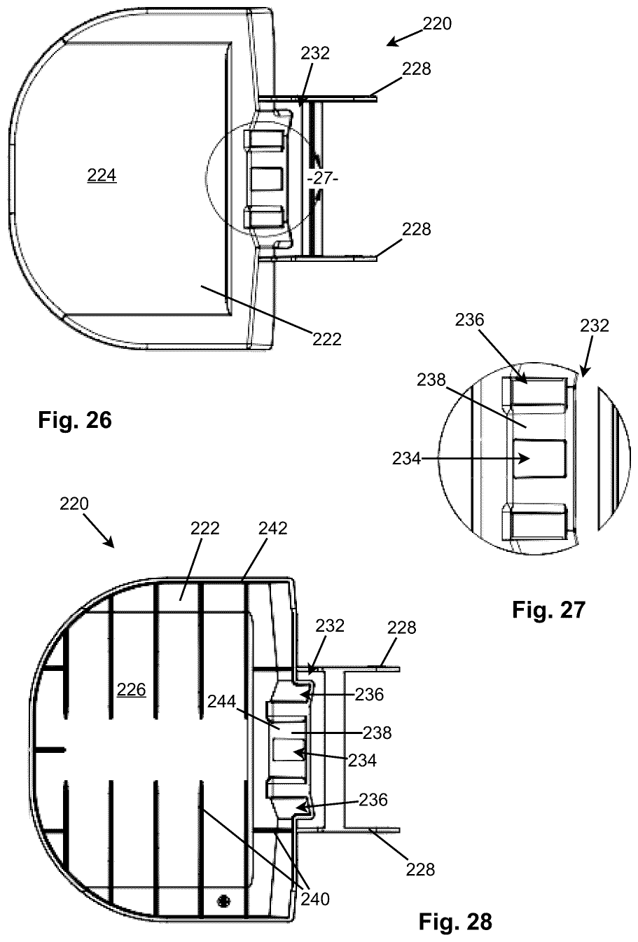

Referring to FIGS. 23 to 28, the gate 220 of the waste container 100 comprises a body 222 having a top face 224 and a bottom face 226. The gate 220 further comprises a pair of protrusions 228 extending rearwards from the body 222 and having holes 230 therein distant from the body 222 for the gate-mounting lugs 176 of the intermediary part 140 to extend therethrough for the body 222 to be able to rotate therearound. The gate 220 further comprises, rearwards to the body 222, a perforated panel 232 defining a wall 238 comprising a central opening 234 and two side openings 236. The central opening 234 provides a passage to the coupling member 260, while the side openings 236 provide passage to the push members 204 of the base 182 and the hooks 166 of the intermediary part 140. The wall 238 has a bottom face that interface with the hooking end 172 and the members as explained further hereinafter.

According to an embodiment, the side openings 236 have chamfered edges for facilitating the inserting of the hooks 166 therein.

It is to be noted that according to an embodiment, the shape of the top face 224 of the body is such as waste material laid over tends to slide away from the side edges of the body 222. The shape of the top face 224 and the shape of the bottom edge 156 of the internal shell 154 are matching so that when the gate 220 abuts the bottom edge 156 of the internal shell 154 of the intermediary part 140, the interface limiting air flow therebetween.

According to an embodiment, the bottom face 226 is made of a protruding edge 242 and a lattice of protruding walls 240 strengthening and rigidifying the body 222 with low increase in weight. According to an embodiment, the lattice is irregular, with some protruding walls 240 spanning more between positions where they are joining other protruding walls 240 or the protruding edge 242.

According to an embodiment, the gate 220 is made of material having a low porosity, and the top face 224 has a smooth finish that favors waste material to easily slide of the top face 224.

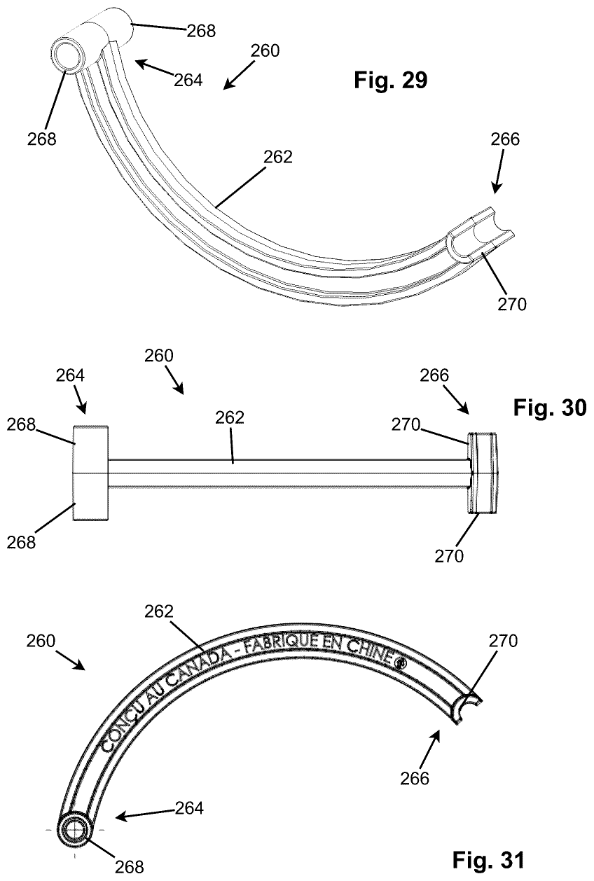

Referring to FIGS. 29 to 31, the coupling member 260 of the waste container 100 that dynamically connects the lid 180 to the gate 220 comprises an arched-shaped body 262, a lid-coupling end 264 and a gate-coupling end 266.

The lid-coupling end 264 comprises a pair of lugs 268 extending sideways to the body 262, designed to be inserted in the channel 198 of the lid 180. The lugs 268 have an external face that has at least partially a cylindrical or frustoconical shape that ease the rotation of the lugs 268 in the channel 198.

The gate-coupling end 266 comprises a pair of lugs 270, extending sideways to the body 262, designed to interface with the wall 238 of the gate 220. The lugs 270 have an external face that has at least partially a cylindrical or frustoconical shape that ease rotation and movement of the lugs 270 over the wall 238 with minimal friction.

According to an embodiment, the lugs 268 and the lugs 270 are volume of revolution. The lugs 270 are volumes resulting from a revolution of over about one hundred and eighty (180) degrees, with the revolution being symmetrical relative to the arched body 262. This partial revolution volume prevents presence of extra volume that may necessitate extra volume inside the waste container 100 for the displacement of the coupling member 260 when the lid 180 in a closed position.

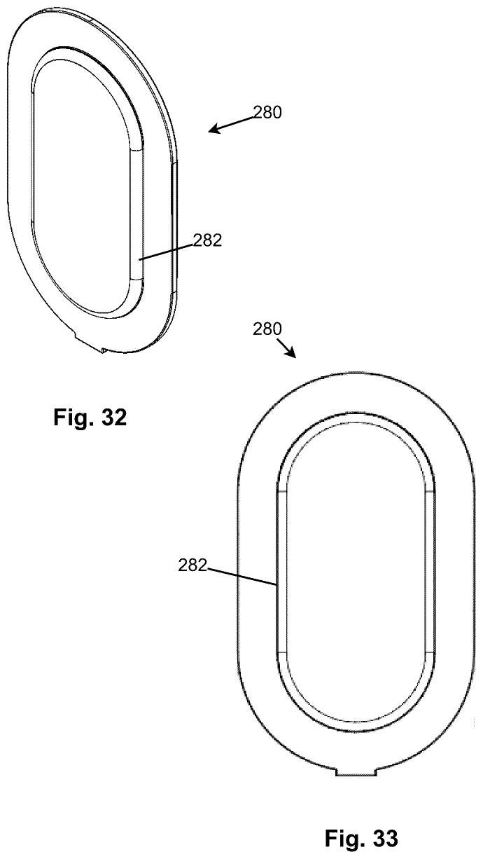

Refining to FIGS. 32 and 33, the transparent window 280 is made of transparent plastic material. The transparent window 280 has an edge 282 that is adapted to have the edge of the opening 178 of the intermediary part 140 wedged therein such as to hold thereto and to provide visual of the content of the room 102 while providing no route for the odors to escape the room 102.

It is to be noted that shape of the intermediary part 140 and location of the transparent window 280 therein ease getting a good visual inside the room 102. The sloped configuration of the internal shell 154 provides some clearance to get a visual above portion of the room 102 inside the base 120.

According to an embodiment, glue is used at the edge 282, permanently securing the transparent window 280.

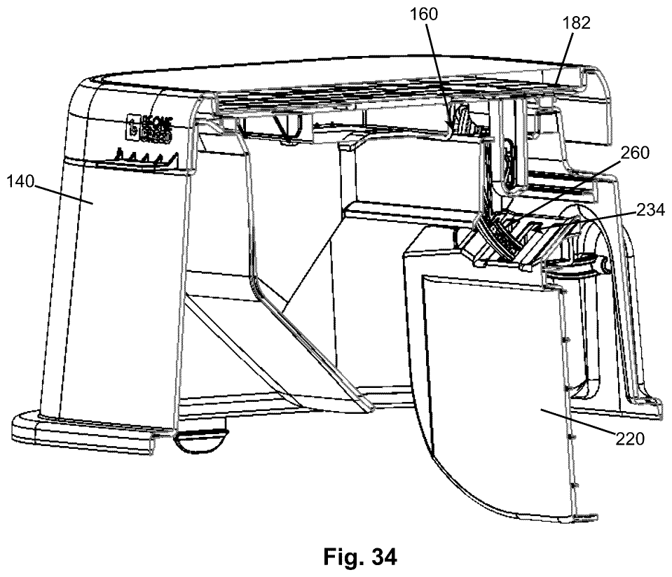

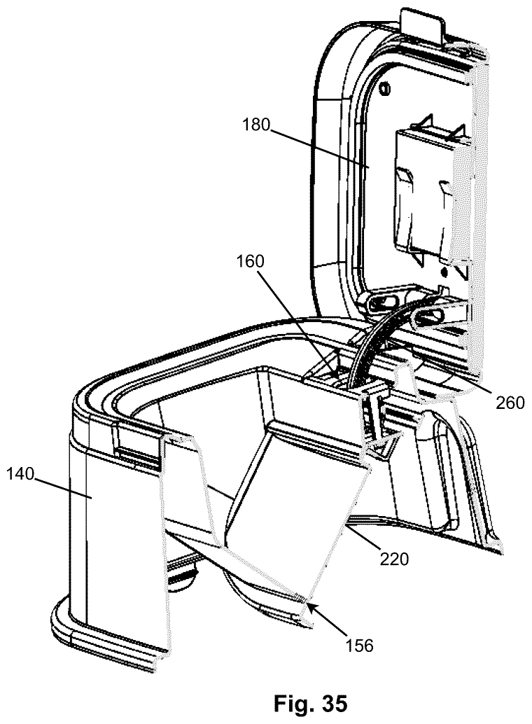

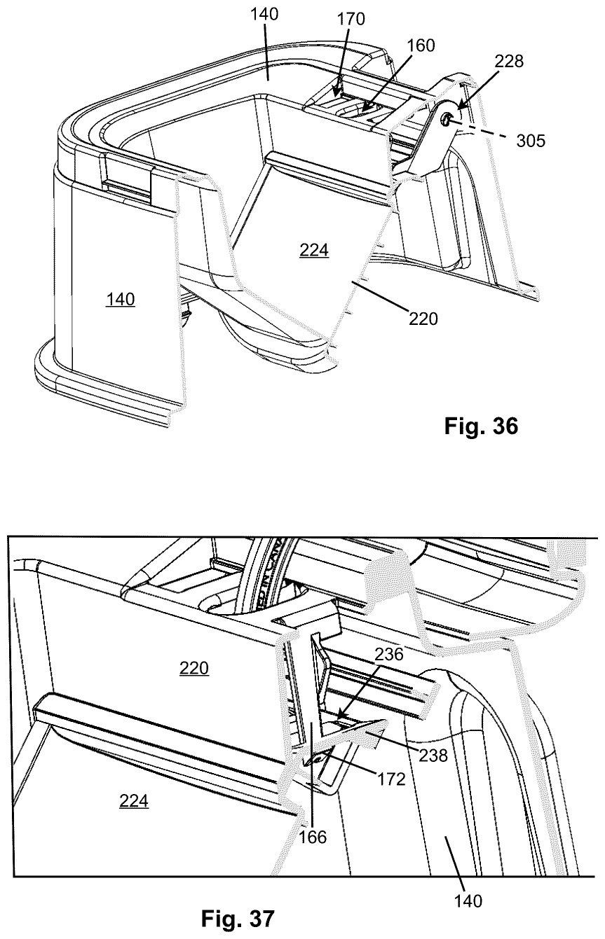

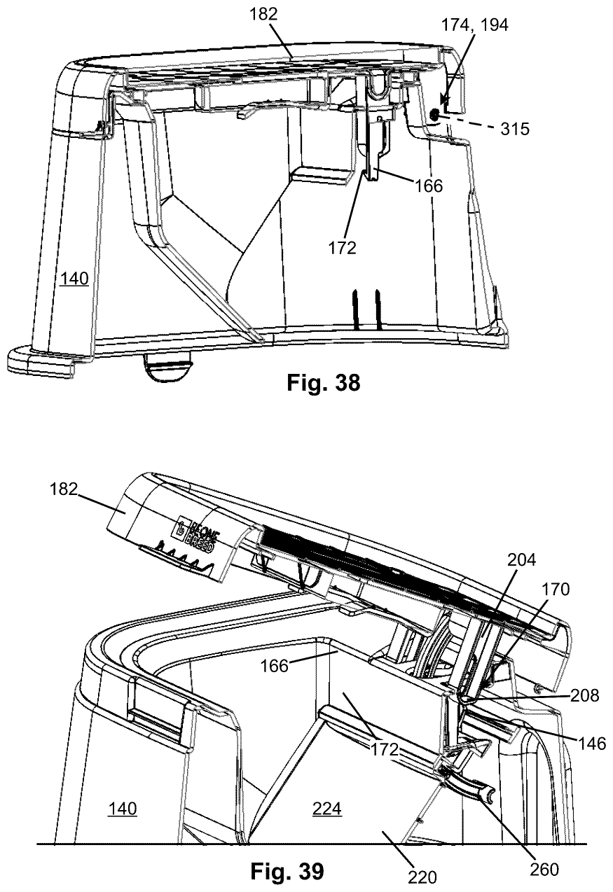

Referring now to FIGS. 34 to 39, there is a description of how the waste container 100 works.

Referring to FIG. 34, in the default configuration of the waste container 100, also called closed waste container 100, the lid 180 (only the lid base 182 depicted) is in a closed position, laying on the intermediary part 140. The coupling member 260 hangs from the lid 180, through the central opening 160 of the intermediary part 140, and the central opening 234 of the gate 220. The gate 220 is rotated freely downwards around the rotation axis 305 (depicted on FIG. 36), and retained in its opened position by the lugs 270 (not visible in FIG. 34) of the coupling member 260 abutting against the wall 238 (not visible in FIG. 34) of the gate 220.

According to an embodiment, the center of mass of the gate 220 results in the lugs 270 and the wall 238 being distant to each other in the opened position of the gate 220.

Referring to FIG. 35, lid 180 is lifted into its opened position. When lifting the lid 180, the coupling member 260 having from the lid 180 travels upwards through the central opening 160 of the intermediary part 140 and the central opening 234 of the gate 220, and abuts against the wall 238 (not visible in FIG. 35) until the gate 220 abuts the bottom edge 156 in its closed position, limiting air flow between the general passage and the room 102.

Referring additionally to FIGS. 36 and 37, in its closed position, the gate 220 is hanging up to the intermediary part 140 through the hooks 166. When lifting the lid 180 (not shown in FIGS. 36 and 37), the hooking end 172 of the hooks 166 are crossing the side openings 236, slightly pushed center-wards by the interface of their shape and the chamfering of the side openings 236, until the hooking ends 172 are below the wall 238. When below, the hooking ends 172 slide back sidewards and abut the bottom face 244 (not visible in FIG. 36 and FIG. 37) of the wall 238 where they retain the gate 220 from rotating downwards.

In this configuration, the lid 180 in the opened position and the gate 220 in the closed position, the gate 220 is anchored and sturdy. And escape of odors from the room 102 is limited to the openings 160, 170. The user may thus place waste material on the top face 224 of the gate 220. The gate 220 and lid 180 are designed to remain in place until a closing action takes place.

It is further to be noted that the odors in that configuration are substantially limited to already ambient odors, such as cat used litter, wherein the odors remain regardless of the used litter being in the litter box or on the gate 220. Thus, a small source of odors from the openings 160, 170 away from the user is not deemed a substantial source of nuisance.

Referring to FIGS. 38 and 39, the opening of the gate 220 requires the hooks 166 to stop retaining the gate 220 in its closed position. When closing the lid 180 by rotating downwards the lid 180 around its rotation axis 315, the abutting ends 208 of the push members 204 are adapted to pass through the side openings 170, and to reach and push against the side protrusion 146 of the hooks 166, forcing them center-wards and thereby disengaging the gate 220 from the hooking end 172. Once disengaged, the gate 220 rotates downwards arounds its rotation axis 305 (visible in FIG. 36), and the waste material placed on top of the top face 224 of the gate 220 falls off in the room 102.

Not displayed specifically, normal use includes of course unhooking the intermediary part 140 from the base 120 when the room 102 is full, and to pick up the liner installed therein with the waste material being solely contained in the liner.

Normal use includes to replace the used liner with a new liner, coupling the liner with the base 120 to ensure that the liner will remain in place. One such solution is to use liners designed for the waste container 100, adapted to be hang from the hooks 124.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A waste container, comprising:
a base providing a room therein for waste material;
an intermediary part to be mounted to the base, the intermediary part comprising an internal shell providing an internal access to the room;
a gate rotatably mounted to the intermediary part, the gate being movable between a gate-opened position wherein the internal access to the room is open, and a gate-closed position where the internal access to the room is blocked by the gate;
a lid rotatably mount to the intermediary part, the lid being movable between a lid-opened position in which an external access to the internal shell of the intermediary part is open, and a lid-closed position in which the internal access to the internal shell is blocked by the lid; and
a coupling member coupling the lid to the gate, wherein moving the lid from the lid-closed position to the lid-opened position exerts the gate into the gate-closed position.

2. The waste container of claim 1, wherein the coupling member has an arched shape.

3. The waste container of claim 1, wherein the base comprises a resting part adapted to be laid over ground, wherein the intermediary part comprises an edge defining a circumference providing an internal opening, wherein the internal opening is adapted to extend slanted relative to the resting part.

4. The waste container of claim 1, wherein the lid-closed position and the gate-closed position are sloped relative to one another.

5. The waste container of claim 1, wherein the coupling member extends across a section of the intermediary part.

6. The waste container of claim 1, wherein the coupling member is slidingly movable relative to the gate.

7. The waste container of claim 1, wherein the intermediary part comprises a protrusion extending across the gate.

8. The waste container of claim 7, wherein the protrusion ends with a hook, wherein the lid comprises a push member adapted to controllably push the protrusion, thereby having the hook releasably hooking the gate.

9. The waste container of claim 1, wherein the internal shell had a funnel shape having a first opening area about the base and a second opening area about the lid, wherein the first opening area is smaller than the second opening area.

10. The waste container of claim 1, wherein the coupling member is rotatably mounted to the lid.

11. A waste container, comprising:
a holding member providing a room therein for waste material, the holding member comprising i) an internal opening that is closeable and divides the room between a first room section and a second room section when closed, and ii) a external opening that is closeable;
a gate mounted to the holding member, the gate being movable between a gate-opened position wherein the first room section and the second room section are unpartitioned, and a gate-closed position where the gate partitions the room thereby preventing travel between the first room section and the second room section;
a lid mounted to the holding member, the lid being movable between a lid-opened position providing access to the first room section, and a lid-closed position in which the lid closes the external opening; and
a coupling member coupling the lid to the gate, wherein moving the lid from a lid-closed position to the lid-opened position exerts the gate into the gate-closed position.

12. The waste container of claim 11, wherein the gate is rotatably mounted to the holding member.

13. The waste container of claim 11, wherein the coupling member has an arched shape.

14. The waste container of claim 11, wherein the holding member comprises a base and an intermediary part releasably mounted to the base.

15. The waste container of claim 11, wherein the holding member comprises a floor section and an internal shell extending from the external opening to the internal opening distant to the floor section.

16. The waste container of claim 11, wherein the holding member comprises a resting part adapted to be laid over ground, wherein the internal opening is adapted to extend slanted relative to the resting part.

17. The waste container of claim 11, wherein the lid-closed position and the gate-closed position are sloped relative to one another.

18. The waste container of claim 11, wherein the coupling member extends across a section of the holding member.

19. The waste container of claim 11, wherein the holding member comprises a protrusion extending across the gate.

20. The waste container of claim 19, wherein the protrusion ends with a hook, wherein the lid comprises a push member adapted to controllably push the protrusion, thereby having the hook releasably hooking the gate.
